(19) United States
(12) Patent Application Publication
(10) Pub. No.: US 2022/0088547 A1
(43) Pub. Date: Mar. 24, 2022

(54) Aerating Bottle Stopper

(71) Applicant: Richard Rude, Landing, NJ (US)

(72) Inventor: Richard Rude, Landing, NJ (US)

(21) Appl. No.: 17/386,760

(22) Filed: Jul. 28, 2021

Related U.S. Application Data
(60) Provisional application No. 63/081,506, filed on Sep. 22, 2020.

(51) Int. Cl. B01F 3/04

(52) U.S. Cl. CPC B01F 3/04794; B01F 2215/0072; B01F 3/04829

(57) ABSTRACT

An aerating bottle stopper comprises a stopper component and an aerator component, which is releasably attached to the bottom of the stopper component by at least one break-away connector. During the bottling of the beverage, the aerating bottle stopper is inserted into the neck of the bottle to seal it. In order to open the bottle, the stopper component is removed causing the break-away connector to separate, releasing the aerator component so that it remains in the neck of the bottle. Multiple flow channels pass through the aerator component. When the beverage is poured through the bottle neck, its flow through the flow channels becomes turbulent so as to cause air to mix with the beverage and aerate it.

### REFERENCE TO RELATED APPLICATION

This application claims the benefit of the filing date of Provisional Application No. 63/081,506, filed Sep. 22, 2020, the disclosure of which is incorporated herein by reference.

### FIELD OF INVENTION

The present invention relates to the general field of bottle stoppers, including natural and artificial corks as well as screw caps, and more particularly to bottle stoppers that incorporate a break-away aerating component.

### BACKGROUND OF THE INVENTION

The taste of certain beverages, notably wine, is improved by aerating the beverage prior to drinking. Wine in particular is said to “breathe” in the presence of oxygen, which brings out the full flavor of the wine. In order to achieve proper aeration, the surface area of the beverage in contact with the air must be maximized. Conventionally, this is done by “decanting” the beverage from its original bottle into a separate container. Decanting is inconvenient, insofar as it requires a special decanter vessel, and if not carefully done, it can cause sediments from the bottom of a bottle to become mixed with the beverage, thereby degrading its flavor. Therefore, there is a need for an aerating system that does not require decanting.

### SUMMARY OF THE INVENTION

The present invention is an aerating bottle stopper and a method of using it to aerate a beverage without decanting it from its original bottle. As used herein, the term “stopper” refers to a natural or artificial cork, a screw cap, a crimp cap, a plastic seal, or a foil seal. The aerating bottle stopper comprises a stopper component and an aerator component, which is releasably attached to the bottom of the stopper component by a releasable connector means. During the bottling of the beverage, the aerating bottle stopper is inserted into the neck of the bottle to seal it. In order to open the bottle, the stopper component is removed—typically with a corkscrew for a cork stopper or by twisting off a screw cap stopper. The removal of the stopper component causes the releasable connector means to separate from between the stopper component and the aerator component, thereby releasing the aerator component so that it remains in the neck of the bottle.

The aerator component comprises a semi-flexible, substantially cylindrical insert, having enough flexibility to allow it to be inserted tightly into the bottle neck while attached to the bottom of the stopper component. The aerator component has a substantially circular proximal end, which is releasably attached to the bottom of the stopper component, and a substantially circular distal end. Multiple flow channels pass through the aerator component from the proximal end to the distal end. When the beverage is poured through the bottle neck, its flow through the flow channels becomes turbulent so as to cause air to mix with the beverage and aerate it.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1A is a perspective view of the first embodiment of the present invention;

FIG. 1B is a side profile view of the first embodiment of the present invention;

FIG. 1C is a front profile view of the first embodiment of the present invention;

FIG. 1D is a top view of the first embodiment of the present invention;

FIG. 1E is an exploded view of the first embodiment of the present invention insertion into a neck of a wine bottle;

FIG. 2A is a perspective view of the aerator component according to the second embodiment of the present invention;

FIG. 2B is a side profile view of the aerator component according to the second embodiment of the present invention;

FIG. 2C is a front profile view of the aerator component according to the second embodiment of the present invention;

FIG. 2D is a top view of the aerator component according to the second embodiment of the present invention;

FIG. 2E is an exploded view of the aerator component according to the second embodiment of the present invention insertion into a neck of a wine bottle;

FIG. 3A is a perspective view of the third embodiment of the present invention;

FIG. 3B is a side profile view of the third embodiment of the present invention;

FIG. 3C is a front profile view of the third embodiment of the present invention;

FIG. 3D is a top view of the third embodiment of the present invention; and

FIG. 3E is an exploded view of the third embodiment of the present invention insertion into the neck of a wine bottle.

### DETAILED DESCRIPTION OF THE PREFERRED EMBODIMENT

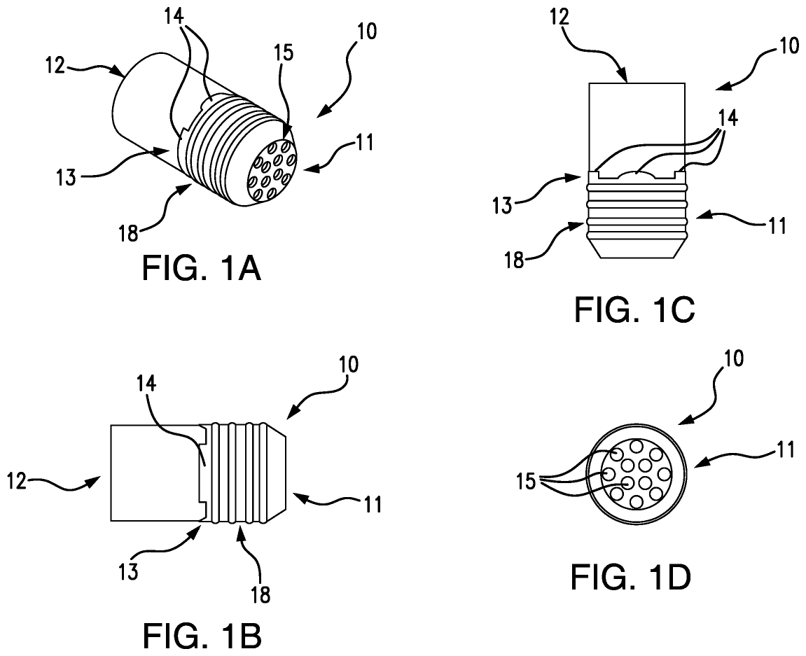

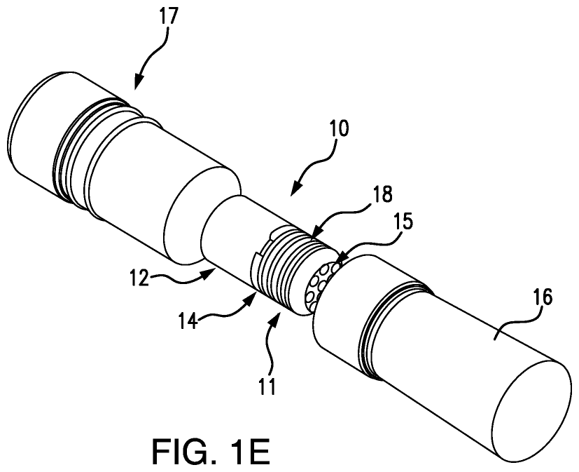

Referring to FIGS. 1A-1E, the first exemplary embodiment of the present invention 10 comprises a semi-flexible aerator component 11, the proximal end of which is friction-fitted to the bottom of a natural or synthetic cork stopper 12 by a releasable connector means 13. In this first embodiment 10, the connector means 13 comprises four flanges 14, which engage the perimeter of the stopper 12 bottom, and which extend from the proximal end of the aerator component 11 at 90-degree intervals and have a maximum extension of 5 millimeters. In this and all embodiments, the aerator component 11 has multiple flow channels 15 which pass through it from its proximal end to its distal end, and the aerator component 11 is sufficiently flexible to form an impermeable seal with the bottle neck 16, without collapsing any of the flow channels 15. FIG. 1E shows an exploded view of the insertion of first embodiment of the aerating bottle stopper 10 into the bottle neck 16 of a wine bottle, with an exemplary aluminum overshell 17 applied to the bottle neck 16 after insertion.

Removal of the natural or synthetic cork stopper 12 from the bottle neck 16 causes the flanges' 14 friction stopper connection between the proximal end of the aerator component 11 and the bottom of the natural or synthetic cork stopper 12 to release, so that the aerator component 11 remains in the bottle neck 16. After removal of the cork 12, wine poured from the bottle will develop a turbulent flow as it passes through the flow channels 15 of the aerator component 11, thereby aerating the wine.

In this and all embodiments of the present invention, the outer cylindrical surface of the aerator component 11 has multiple semi-flexile ridges 18, which engage the interior of the bottle neck 16 and operate to tighten the impermeable seal with the bottle neck 16.

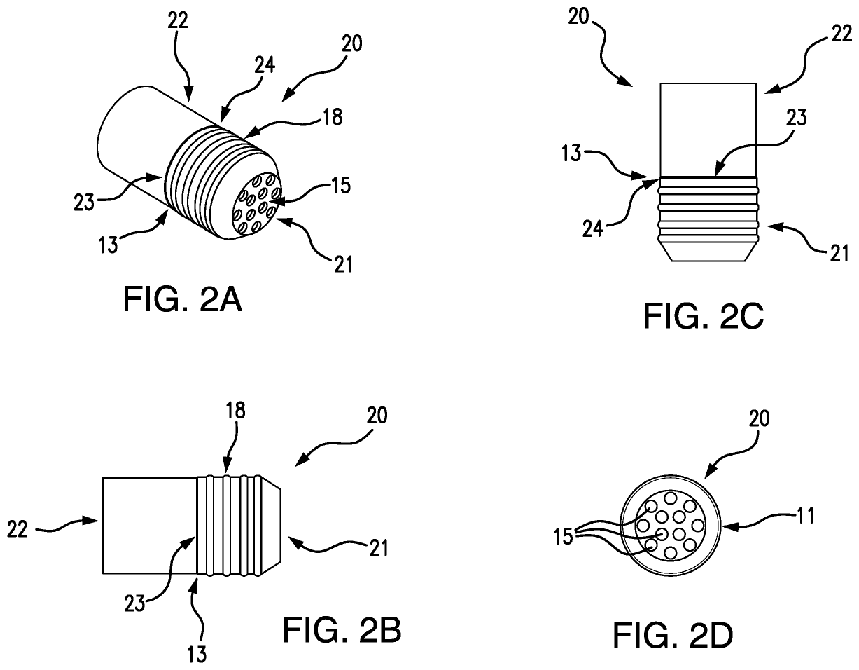

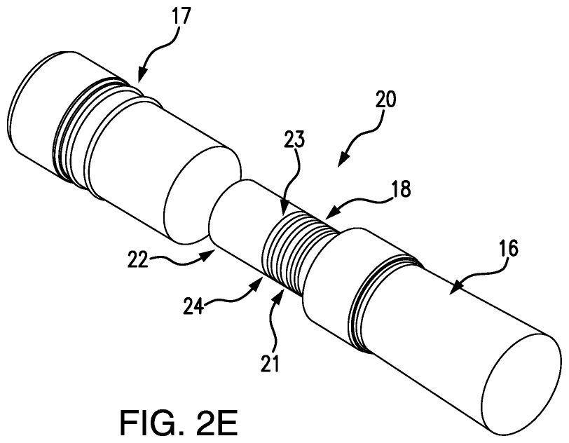

In the second exemplary embodiment of the present invention 20, illustrated in FIGS. 2A-2E, the stopper component is a synthetic cork 22. The aerator component 21 is structurally the same as in the first embodiment 10, except that its connector means 13 to the synthetic cork 22 differs. The aerator component 21 and the synthetic cork 22 are injection molded together from the synthetic cork 22 material, and the connector means 13 comprise multiple injection-molded break-away tabs 23 at the interface 24 between the stopper 22 bottom and the proximal end of the aerator component 21. As with the first embodiment 10, twisting of the cork 22 to remove it from the bottle neck 16 causes the break-away tabs comprising the connector means 23 to release the aerator component 21 from the synthetic cork 22. The aerator component 21 then remains in the bottle neck 16 and there induces an aerating turbulent flow in the beverage poured through its flow-channels 15, as in the first embodiment 10.

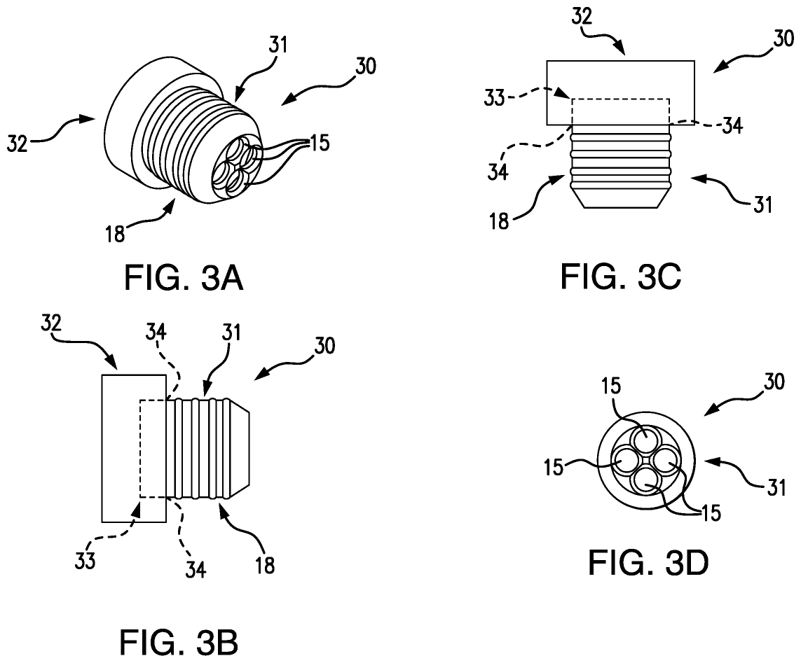

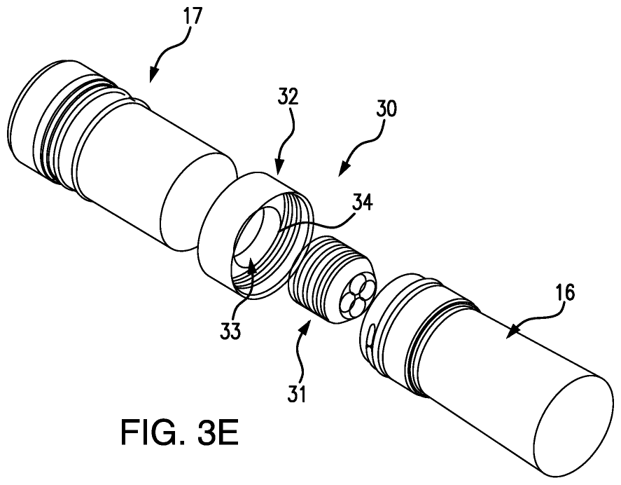

In the third exemplary embodiment of the present invention 30, illustrated in FIGS. 3A-3E, the stopper component is a screw cap 32, which has an interior annular cap seal 33 that fits inside the bottle neck 16. The aerator component 31 is structurally, the same as the first two embodiments 10 20, except its connector means 13 to the cap seal 33 comprises a releasable adhesive 34 applied between the cap seal 33 and the proximal end of the aerator component 31. As with the first two embodiments 10 20, twisting of the screw cap 32 causes the adhesive 34 bond between the cap seal 33 and the proximal end of the aerator component 31 to break, so that the aerator component 31 remains in the bottle neck 16 and there induces an aerating turbulent flow through its flow channels 15 in the poured beverage.

Although the preferred embodiments of the present invention have been disclosed for illustrative purposes, those skilled in the art will appreciate that many additions, modifications and substitutions are possible, without departing from the scope and spirit of the present invention as defined by the accompanying claims.

What is claimed is:

1. An aerating bottle stopper inserted in a bottle neck of a bottle containing a beverage, the aerating bottle stopper comprising:
a stopper component, comprising a substantially cylindrical stopper, and having a substantially circular stopper top and a substantially circular stopper bottom;
an aerator component, which is semi-flexible and substantially cylindrical, and which has a substantially circular proximal end and a substantially circular distal end, wherein a releasable stopper connection is formed between the proximal end of the aerator component and the stopper bottom by a releasable connector means, and wherein multiple flow channels pass through the aerator component from the proximal end to the distal end, and wherein the aerator component is operable to flexibly form an impermeable seal with the bottle neck without collapsing any of the flow channels;
wherein removal of the stopper from the bottle neck causes the connector means to release the stopper connection, so that the aerator component remains in the bottle neck, and such that a flow of the beverage poured from the bottle becomes turbulent in the flow channels, thereby aerating the beverage.

2. The aerating bottle stopper according to claim 1, wherein the stopper comprises a natural or synthetic cork material, and wherein the connector means comprises multiple flanges which extend at uniform intervals from the proximal end of the aerator component at a maximum flange extension of five millimeters, and wherein the multiple flanges releasably engage a perimeter of the stopper bottom.

3. The aerating bottle stopper according to claim 1, wherein the stopper comprises a synthetic cork material, and wherein the aerator component and the stopper are injection-molded together from the synthetic cork material, and wherein the connector means comprises multiple injection-molded break-away tabs at an interface between the stopper bottom and the proximal end of the aerator component.

4. The aerating bottle stopper according to claim 1, wherein the stopper comprises a screw cap, and wherein the screw cap has an interior comprising a concentric annular cap seal which fits inside the bottle neck, and wherein the connector means comprises a releasable adhesive applied between the cap seal and the proximal end of the aerator component.

5. The aerating bottle stopper according to any one of claims 2-4, wherein the aerator component has a cylindrically curved outer surface, and wherein the outer surface of the aerator component contains multiple, semi-flexible ridges which are operable to engage the bottle neck, thereby tightening the impermeable seal with the bottle neck.

6. A method for aerating a beverage as the beverage is poured through a neck of a bottle, the method comprising the following steps;
(a) providing the aerating bottle stopper according to any one of claims 2-4;
(b) removing the stopper component from the neck of the bottle, such that the connector means separates, releasing the aerator component from the stopper component;
(c) retaining the aerator component in the neck of the bottle; and
(d) pouring the beverage through the constricted flow channels in the aerator component, causing the flow of the beverage to become turbulent, thereby aerating the beverage.

7. A method for aerating a beverage as the beverage is poured through a neck of a bottle, the method comprising the following steps;
(a) providing the aerating bottle stopper according to claim 5;
(b) removing the stopper component from the neck of the bottle, such that the connector means separates, releasing the aerator component from the stopper component;
(c) retaining the aerator component in the neck of the bottle; and
(d) pouring the beverage through the constricted flow channels in the aerator component, causing the flow of the beverage to become turbulent, thereby aerating the beverage.
